(19) United States
(12) Patent Application Publication
(10) Pub. No.: US 2021/0016114 A1
(43) Pub. Date: Jan. 21, 2021

(54) Fall Prevention System

(71) Applicant: Gary J. Franke, Camarillo, CA (US)

(72) Inventor: Gary J. Franke, Camarillo, CA (US)

(21) Appl. No.: 16/513,241

(22) Filed: Jul. 16, 2019

(51) Int. Cl. A62B 35/00; E04G 21/32

(52) U.S. Cl. CPC A62B 35/005; A62B 35/0068; E04G 21/3204; A62B 35/0006

(57) ABSTRACT

A fall prevention system (FPS) that is placed adjacent a multi-level structure such as a frame building, that is being constructed. The FPS has a lower anchor, at least one vertical member, at least one connecting member and an upper member with or without a horizontal section. The number of vertical members utilized depends on the number of levels the structure has. The vertical members are preferably made of metal and are dimensioned to correspond to either the height of a single structure level, or the height of another structure locations such as a peaked roof. The FPS is secured to the ground surface by bolts inserted through the anchor, and at least one securing cable that is attached to cable securing means on the FPS and to a location on the structure. An individual working on the structure wears a harness to which is secured one end of a harness cable. The other end of the harness cable is attached to the cable securing means on the FPS. If the individual is about to fall from the structure, the harness cable locks, thereby stopping the fall occurring.

### TECHNICAL FIELD

The invention generally pertains to fall avoiding devices, and more particularly to a fall prevention system that is used on a multi-level structure that is being constructed.

### BACKGROUND ART

During construction of multi-level structures, including resident and commercial, there are many dangers the individuals performing the construction must content with by a frame made of wood or other material present a danger of falling. This fall danger is a result of a structure in a frame state having open sides, which require workers to maintain concentration and balance. A fall from even a second story height can cause major injury or death. In the United States, the Occupational Safety and Health Administration (OSHA) is responsible for creating and enforcing a safe working environment at a construction site. One requirement is for a fall arrest device for people working at height. Some of the OSHA requirements are created for certain environments, others are not completely outlined for residential, commercial or other multiple story structures.

There have been attempts such a scaffolding to provide safety for workers constructing a multi-level building, especially one with a frame structure. While some of these attempts are effective they also have drawbacks such as increased time, effort and cost to assemble, and restricting access to certain areas.

There is definitely a need to provide prevention to individuals who are working on a multi-level frame structure, but the prevention should not interfere with the requirements of the construction. Optimally, a fall prevention system or device could provide effective prevention against a fall or from an injury resulting from a fall. The system would need to be un-obtrusive and not negatively impact an individual's ability to perform the necessary work. Also, the system would be adaptable for use with any frame structure, could be transported to a structure being constructed, and could be quickly and easily set up, and then removed when no longer required.

Another benefit would be to provide an individual with some control over their own personal prevention, thereby allowing the individual to ensure their fall prevention is securely in place.

A search of the prior art did not disclose any literature or patents that read directly on the claims of the instant invention. However, the following U.S. patents are considered related:

| U.S. Pat. No. | INVENTOR | ISSUED |
|---|---|---|
| 5,522,472 | Shuman, Jr. et al | Jun. 4, 1996 |
| 6,016,889 | Pearcy et al | Jan. 25, 2000 |
| 6,334,507 | Westerweel | Jan. 1, 2002 |
| 6,695,095 | Franke | Feb. 24, 2004 |

Shuman Jr. et al in U.S. Pat. No. 5,522,472 discloses a full protection system for bridge construction that includes T-shaped cable supports secured to the concrete support columns of a bridle or overpass during construction. Cables are attached between the supports and receive a number of sideable, safety belt attachments, A construction worker wearing the appropriate safety harnesses us protected from falls as the cable secures the harness and yet leaves sufficient room for normal activity of the worker.

U.S. Pat. No. 6,016,889 issued to Pearcy et al protects a climber from falling from a pole by utilizing a housing that fits over the top of the pole which includes a swing arm extending therefrom to which a fall protection device is attached. The swing arm may also include a cam follower assembly that includes a support component spaced apart from a closed end of the housing.

Westerweel in U.S. Pat. No. 6,334,507 discloses a fall protection system that includes a trolley that moves along anchoring lines. The anchoring lines are arranged in a parallel spaced position. The trolley has a running gear that makes contact with the lines inn a low noise and vibration manner, which enables easy passage without limiting the working space of the user.

Franke in U.S. Pat. No. 6,695,095 discloses a fall protection restraint apparatus that is utilized during building construction. The apparatus has a base that rests on the lowest floor surface of a building during construction. Poles are connected to the base sequentially, to form a column. Support cables are connected between the poles and the building. A retractable lanyard is attached to D-rings on an end cap on the uppermost pole, thereby allowing the lanyard to expand and retract freely until a sudden tug impedes and secures the lanyard's movement. A construction worker wears a fall arrest harness that is connected to the lanyard, thus providing protection.

For background purposes and indicative of the art to which the invention relates, reference may be made to the following remaining patents found in the patent search.

| U.S. Pat. No. | INVENTOR | ISSUED |
|---|---|---|
| 3,807,089 | Senese | April 1974 |
| 4,224,722 | Mikosz et l | September 1980 |
| 4,537,395 | Spinelli | August 1985 |
| 4,878,274 | Patricy | November 1985 |
| 5,186,289 | Wolner et al | February 1993 |
| 5,307,897 | Turner et al | May 1994 |
| 5,363,610 | Thomas et al | November 1994 |
| 6,443,433 | Auldridge | September 2002 |
| 6,446,408 | Gordin et al | September 2002 |
| 2002/0079164 | Choate | June 2002 |

### DISCLOSURE OF THE INVENTION

When building a multi-level structure, especially a structure that uses a frame design with open sides during much of the construction, construction individuals are susceptible to falling from the structure. Depending on the height from which an individual falls, the result could be minor injury, major injury or death. A fall prevention system (FPS) provides a solution to the danger of falling. The FPS is designed to prevent a fall from occurring and to lessen the likelihood of injury or death from a fall.

The FPS utilizes a tower structure that is assembled adjacent a building being constructed. The FPS can be sequentially heightened as levels are added to the building. The FPS has a small footprint and does not interfere with the construction in any way. The FPS has a lower anchor that is secured to a ground surface. The securing is accomplished by preferably inserting multiple bolts through the anchor and into the ground which is a strong material such as concrete. Extending upward from the anchor is a vertical member that typically has a height substantially equal to the height of one level of the structure. As additional levels are built, additional vertical members are added to the FPS. A connecting member is utilized to secure one vertical member to another vertical member. At the top of the FPS is an upper member which can include a horizontal section that creates a T-shape. A second vertical member can telescope upward from within a lower vertical member. A winch assembly is configured on the lower vertical member, with a cable extending from the winch and secured to the second vertical member, which rises and lowers as the winch is actuated.

Located on the vertical member, connecting member(s) and/or upper member is at least one cable securing means which is preferably a D-ring, but could also be other means such as a cotter pin assembly. An individual working on a structure wears a harness. A harness cable has a first end secured to the harness and a second end secured to the cable securing means. The individual wears the harness with the secured harness cable at all times when he/she is working at an elevated level. If the individual has an accident the FPS can either prevent the individual from falling from the structure, or if the individual does fall off the building, the FPS will prevent the individual from continuing down any distance.

To increase the functionality and safety of the FPS the following can be included: a cable ratchet that allows the securing cable attached to a structural location to be tightened and any slack removed. A retracting/extending device operates as the ratchet provides the same function for the harness cable that tethers the individual to the FPS. A fall indicator, in the form of a light or an alarm can notify other people that an individual has either fallen or almost fallen and shows, the location of the individual. And finally, a body winch can be utilized to lift or lower an individual who has fallen off a building.

In view of the above disclosure, the primary object of the invention is to provide a fall prevention system that will prevent an individual from falling from a multi-level structure being constructed, and prevents injury or death that would result from a fall.

In addition to the primary object of the invention it is also an object of the invention to provide a fall prevention system that:
is easy to use,
can be used with various types of structures,
can be quickly assembled and disassembled,
is easy to transport,
can be used by multiple individuals,
is durable and long-lasting,
is cost effective from both a manufacturer's and construction company's point of view.

These and other objects and advantages of the present invention will become apparent from the subsequent detailed description of the preferred embodiment and the appended claims taken in conjunction with the accompanying drawings.

### BRIEF DESCRIPION OF THE DRAWINGS

FIG. 1 is an elevational view showing an individual secured to a fall prevention system (FPS) that is located at and secured to a multi-level structure that is being constructed.

FIG. 2 is an elevational view showing the FPS that is located at and secured to a multi-level structure that is being constructed.

FIG. 3 is an elevational view showing the FPS lower anchor bolted to a ground surface.

FIG. 4 is an elevational view showing the FPS vertical member inserted into a connecting member with cable securing means on the connecting member.

FIG. 5 is an elevational view showing the FPS lower anchor with the lower end of the vertical member inserted into the anchor, and the upper end of the vertical member inserted into a connecting member.

FIG. 6 is an elevational front view showing the FPS upper member having a horizontal section with D-ring cable securing means

FIG. 7 is an elevation side view showing the FPS upper member having a horizontal section with cotter pin assembly cable securing means.

FIG. 8 is an elevational front view showing the FPS upper member having a horizontal section with no cable securing means.

FIG. 9 is an elevational view showing the FPS lower anchor and vertical member integrally connected into a single unit.

FIG. 10 is an elevational view showing the FPS located at a multi-level structure, with the FPS having a light and an alarm that is heard from a speaker.

FIG. 11 is an orthographic front view of the FPS with a second vertical member retracted downward into a lower vertical member, and a winch assembly on the lower vertical member.

FIG. 12 is an orthographic front view of the FPS with a second vertical member extended outward from within a lower vertical member, and a winch assembly on the lower vertical member.

FIG. 13 is an orthographic showing the FPS winch assembly.

FIG. 14 is an orthographic view showing the lower anchor integrally attached to an anchor base which has two handles.

FIG. 15 is a top plan view showing the lower anchor integrally attached to the anchor base which has two handles.

### BEST MODE FOR CARRYING OUT THE INVENTION

The best mode for carrying out the invention is presented in terms that disclose a preferred embodiment of a fall prevention system (FPS) 10. When constructing a multi-level structure, especially a structure with frame that has open sides, there is a serious risk of construction workers falling from the structure, which can result in death or major injury. There have been apparatuses and devices produced that address the problems of falling. While some of these do perform the required function, they are often difficult to set up and use, expensive and can interfere with the normal workflow.

What is needed is a system that could be easily implemented to prevent a fall off a multi-level structure from occurring. The system would actually serve dual purposes: preventing a fall from occurring and mitigating an injury that would result from a fall. The FPS 10 accomplishes these purposes by providing a system that is easy to assemble (and disassemble) at a construction location, is robust and reliable, can perform a variety of fall prevention functions, and is economical to use. The FPS 10 meets all of the United States Occupational Safety and Health Administration (OSHA) requirements for fall arrest, and protects workers during all phases of a constructing framing process. The FPS is effective when installing exterior walls, setting roof trusses, sheathing a roof or installing fascia. Additionally, the FPS 10 is very cost effective since a construction company no longer must stock, repair and replace more than thirty different scaffolding parts. The FPS 10 only requires two people less than one hour to set up and tear down, as opposed to the full day required for scaffolding. There is also no exposure to significant fines resulting from incorrectly set-up scaffolding.

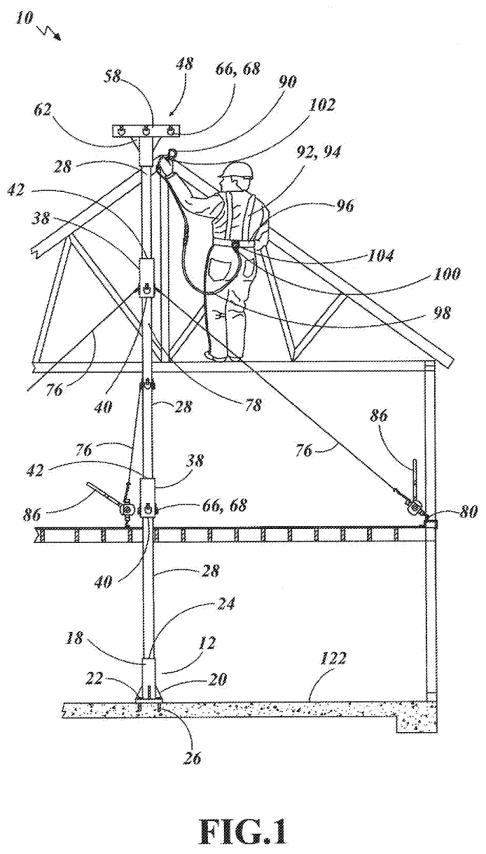

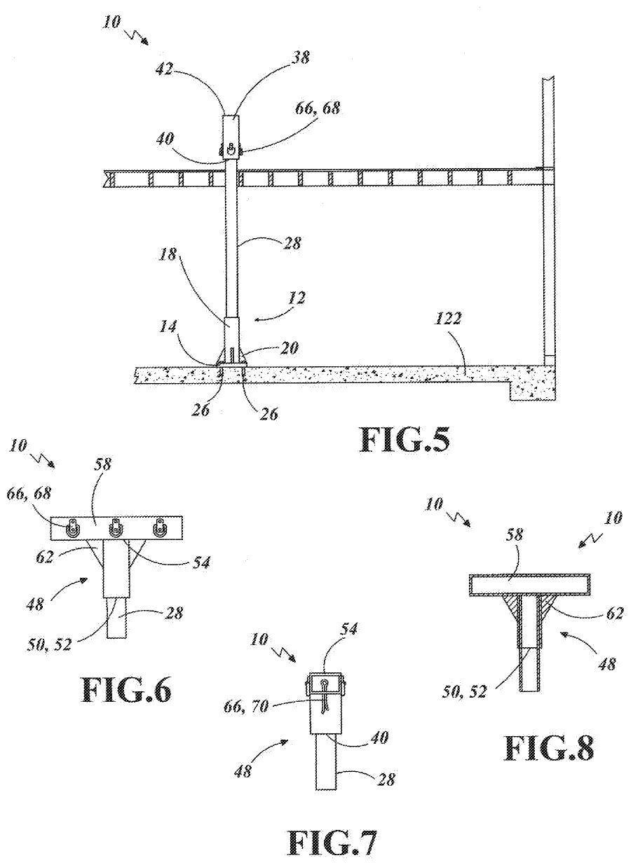

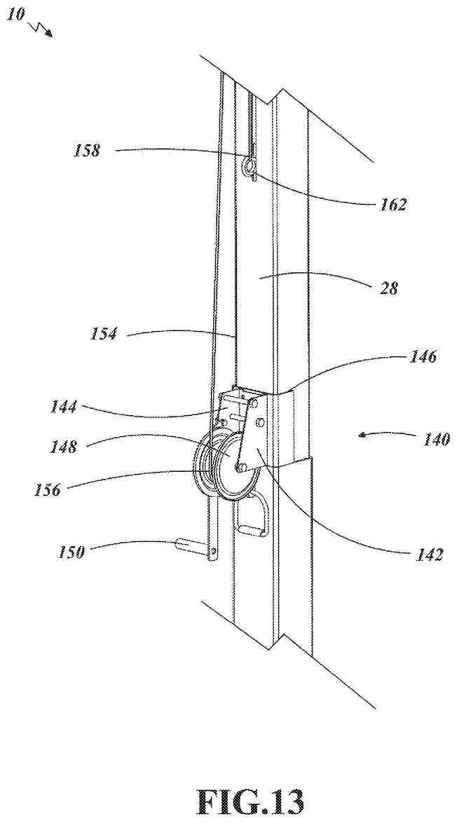

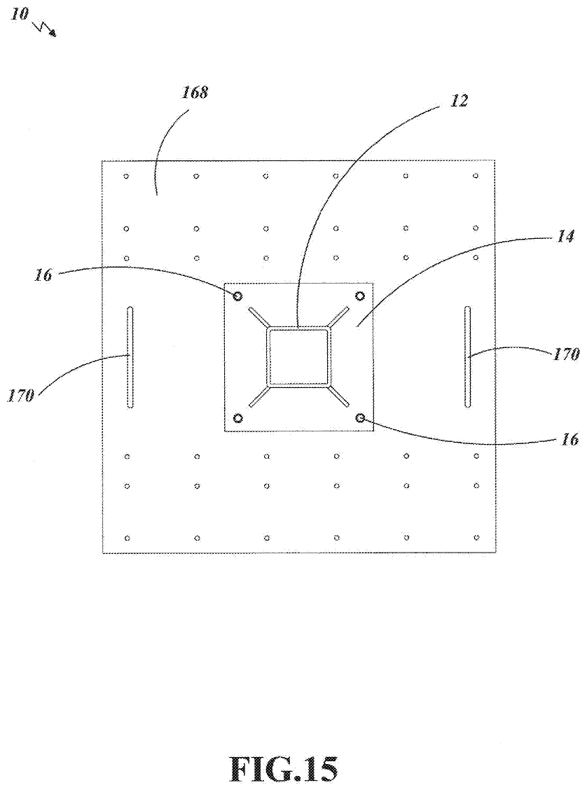

The FPS 10, as shown in FIGS. 1-15, is comprised of the following major elements: a lower anchor 12, at least one vertical member 28, at least one connecting member 38 and an upper member 48. All of the members are preferably made of metal although other materials such as reinforced plastic or wood could also be utilized. The members are preferably square tubing, with other shapes such as circular or triangular also effective.

The lower anchor 12, as shown in FIGS. 1, 2, 3, 5, 10, 11 and 12, is configured to be secured onto a stationary ground surface 122 such as a concrete floor, of a multi-level structure being constructed. The lower anchor 12 includes a bottom plate 14, with bolt bores 16, a vertical section 18, a support gusset 20, and an opening 24. The bottom plate 14 is placed on the ground and a bolt 26 is inserted through each bolt bore 16 and into the ground, thereby securing the lower anchor 12 to the ground 122. Extending upward from the center of the bottom plate 14 is the vertical section 18. As shown in FIGS. 1, 2, 3, 4 and 10, the support gussets 20 are located around the perimeter of the vertical section 18, and preferably forms a triangular element with a downward angle 22 edge. Located at an upper end of the vertical section 18 is an opening 24.

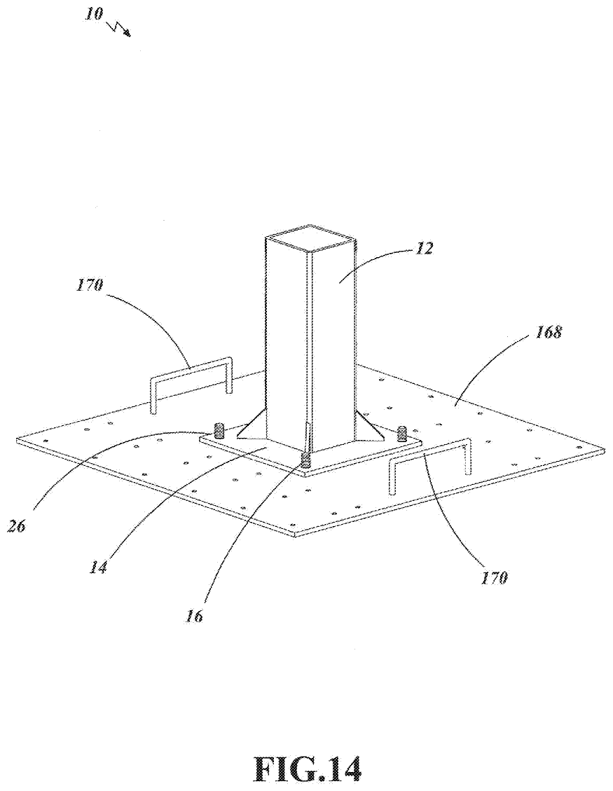

Also, the lower anchor 12 an be integrally attached to the anchor base 108, as shown in FIG. 14. The anchor base has two oppositely positioned handles 170 extending upward from an upper surface of the base 168. The handles 170 allow the anchor base 108 and anchor 12 to be grasped, lifted and carried.

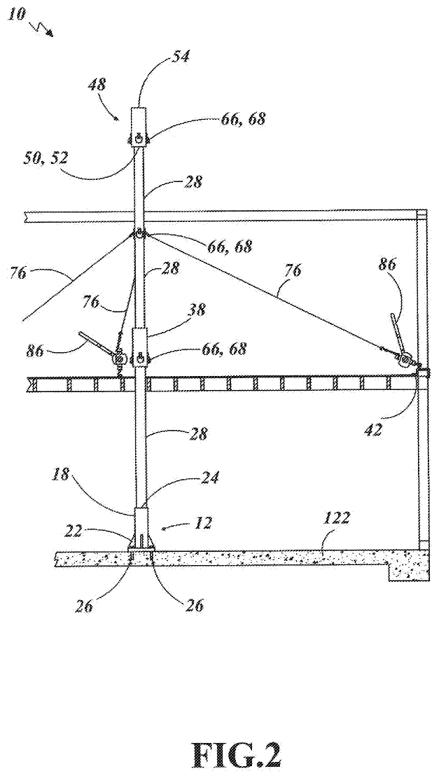

As shown in FIGS. 1, 2, 4-12, the vertical member 28 has a lower end 30, an upper end 32, and an opening 34. The vertical member 28 can be any length, but preferably extends to the height of one level that is being constructed (one level being synonymous with a single story of a multi-level structure). The vertical member lower end 30 is dimensioned to fit into the opening 24 at the upper end of the lower anchor's vertical section 18. To increase the securement of the vertical member within the anchor, multiple type of attachment means can be used, such as a pin 36 that is inserted through corresponding pin bores on the anchor and vertical member, as shown in FIGS. 1 and 2.

The connecting member 38, as shown in FIGS. 1, 2, 4 and 5, has a lower opening 40 and an upper opening 42. The openings 40,42 on the connecting member 38 are dimensioned to interface with the openings on the vertical member. The connecting member 38 is placed on an upper end of a first vertical member 28, with the vertical member's upper end 32 inserted into the connecting member's lower opening 40. A second or subsequent vertical member 28 then extends upward from the connecting member, by inserting the second vertical member's lower end into the connecting member's upper opening 42. By adding connecting members and vertical sections the FPS 10 can be extended upward at each level of a multi-level structure.

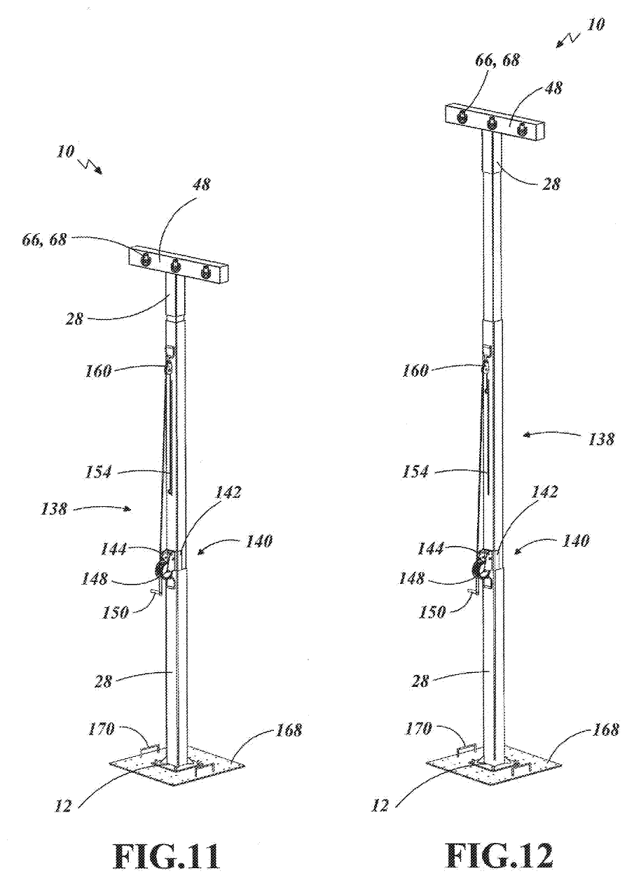

As shown in FIGS. 11 and 12, a telescoping system 138 allows the second vertical member 28 to telescope upward from within a lower vertical member 28. The telescoping action is facilitated by a winch assembly 140. As shown in FIGS. 11-13, the winch assembly comprises a frame 142 configured on the lower vertical member and having an outer U-channel 144, and an U-channel 146, a spool 148 is configured within the outer U-channel, and a hand crank 150 attached to the spool 148 and extends from the outer U-channel 144, a cable 154 comprises a first end 156 secured to the spool, and a second end 158 extending upward from the spool 148, through an upper cable looping member 160, downward, and then secured to a lower cable attachment 162.

The winch assembly 140 can be permanently configured on the lower vertical member by means such as bolts, screws, welding or an adhesive. The winch assembly 140 can also be removably configured on the lower vertical member by means such as a securing band, gripping arms or at least one magnet. Additionally, the winch assembly 140 can comprise a motor that facilitates powered extension and retraction of the second vertical member from within a lower vertical member.

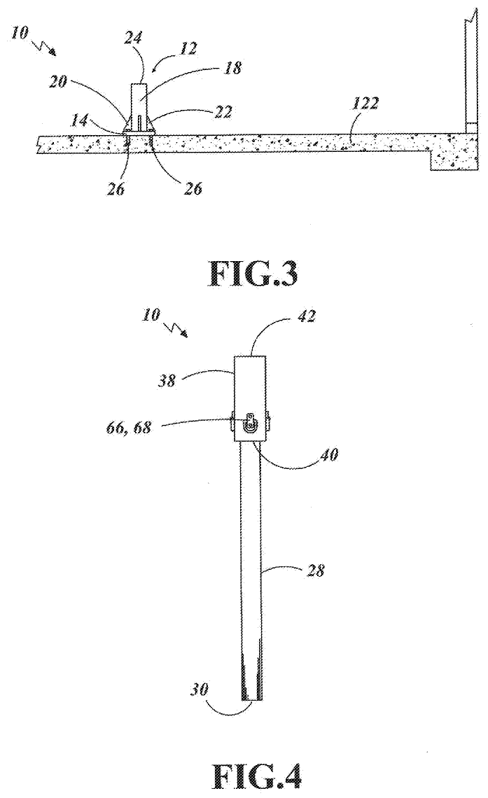

As shown in FIGS. 1, 2, 6-8, 10, 11 and 12, the upper member 48 is attached to an upper end of the vertical member or the top vertical member when multiple vertical embers are utilized. The upper member 48 has a lower end 50 with an opening 52, an upper end 54, and a horizontal section 58. The opening 52 on the upper member's lower end is dimensioned to allow the insertion of a vertical member's upper end 32. The perpendicular orientation of the horizontal section 58 creates a T-shaped member, as shown in FIGS. 3, 6-8. As with the other elements, the upper member 48 is preferably secured to the vertical member. Attachment means 60, such as the previously disclosed pin 36, function as one example of effective attachment means to add structural integrity to the upper member 48. Support gussets 62, as shown in FIGS. 6-8, can also be located around the upper member 38 to increase structural integrity.

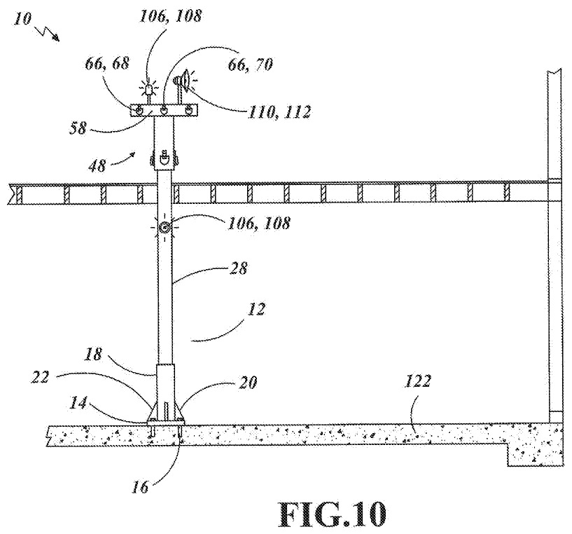

As shown in FIGS. 1, 2, 4, 5-7, 9 and 10, located on the vertical member 28, connecting member 38 and/or upper member 48 are cable securing means 66. The cable securing means 66 are preferably comprised of a D-ring 68 that is attached to the member 27,38 and/or 48. The D-ring 68 can be attached to a plate and the attachment means can include welding, a strong adhesive or other device/substance/method. Also, in lieu of a D-ring other cable securing means such as a cotter pin assembly 70, as shown in FIGS. 7 and 10, can be utilized.

Secured to, and extending from the cable securing means 66 is a securing cable 76 with a first end 78 and a second end 80. The securing cable 76, as shown in FIGS. 1 and 2, can be made of various materials including metal, plastic/nylon or a composite material. The securing cable 76 functions to secure and stabilize the FPS 10 that is located adjacent to the building structure. As shown in FIGS. 1 and 2, the cable's first end 78 is secured to a cable securing means 66 on one of the members 28,38,48. The cable's second end 80 is secured to a structure location 84 such as the building wall or floor. When both ends of cable are secured, the securing cables form a guyed matrix, which maintains the FPS 10 is position. Located on the cable 76 is a cable ratchet 86, as shown in FIGS. 1, 2, and 10, which allows the cable 76 to be tightened and removing slack. Instead of a securing cable 76, at least one securing rod 88 with a clamp 90 at each end can be utilized. One clamp is secured to the FPS 10 and the other clamp is secured to a frame section of a building. Once in place and secured, the rod 88 maintains the FPS in position, secured to the building frame.

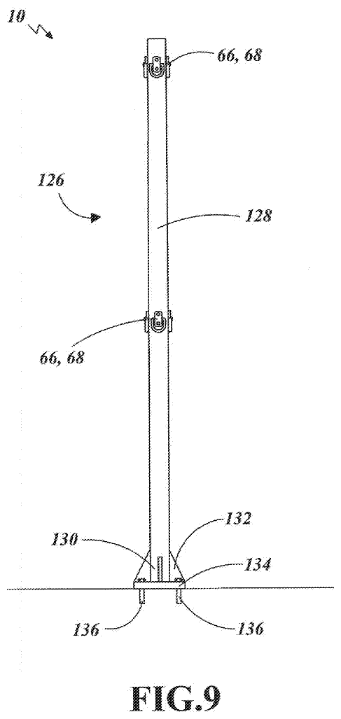

As shown in FIG. 1, when utilize the FPS 10, a construction individual will wear a hardness 92 that is comprised of either a body belt 94 or a waist belt 96. Attached to, and extending from, the harness 92 is a harness cable 98 that has a first end 100 attached to the harness 92 the construction individual is wearing and a second end 102 with either a clip 90 that attaches to the D-ring, as shown in FIG. 1, or an eyelet for the cotter pin assembly. As a component of the harness cable 98, a retracting/extending device 104 is located either adjacent the cable securing means 66 or on the harness 92. The retracting/extending device 104 functions in a similar manner to a vehicle seat belt to allow the cable 97 to be extended to a required length and then maintained at that length, thereby removing loose cable and slack A pulling pressure on the cable “un-locks” the cable. Once the FPS is no longer being used, the retracting/extending device retracts the cable inward around an interior spool. If an individual does begin to fall from the structure, the device 104 locks the length of the cable, thereby preventing the individual continuing to fall. In an alternate design, the FPS 10 lower anchor 12 and vertical member 28, can be manufactured as an integral, one-piece unit, as shown in FIG. 9, with the lower anchor member 130, the vertical member number 128, the gussets 132, the bolt bores 134 and the bolts 126. For the integral design, the FPS can be made to reach any height, so the connecting member(s) are not required. The upper member is optional and can be included if necessary or desired.

To add to the safety features of the FPS 10, a fall indicator 106, as shown in FIG. 10, can be used. The fall indicator 106 is comprised of a light 108 located on the FPS 10 and/or on the harness worn by a construction individual. The light 108 can use a bulb or cover that is colored bright red, yellow or another easily seen color, and can be constantly on or blinking. Additionally, a non-colored light can be used to provide illumination onto the level(s) that are being constructed. The fall indicator 106 can also be comprised of an alarm 110 that can be amplified and played through a speaker 112. As with the light, the alarm/speaker can be located on the FPS 10 and/or harness 98. As the name indicates, the fall indicator presents a visible and/or audible notification that an individual has fallen and shows where the individual is.

And finally, the FPS 10 can also include a body winch 116, as shown in FIG. 1. The winch 116, along with winch controls 118, can be located on the FPS 10 on the harness 48. The winch 116 allows an individual who may be too weak or injured to automatically raise or lower themselves from an angled or even dangling position off a structure after a fall. This is especially important if an individual falls when there is no one else in the vicinity or when a large/heavy individual falls and the other person/people present are not able to pull or lift the individual. In certain situations the winch could also be used to lower an individual if the need arises.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A fall prevention system (FPS) comprising:
a lower anchor having an opening,
a first vertical member dimensioned to fit within the lower anchor opening,
a connecting member extending from the first vertical member,
a second vertical member extending from the connecting member,
an upper member attached to the second vertical member,
at least one securing cable attached to one of the first and second vertical members and a secure location of a structure, and
a harness configured to be worn by a person and having a harness cable that is secured to one of the first and second vertical members or connecting member.

2. The fall prevention system of claim 1, wherein a telescoping system allows the second vertical member to telescoped upward from within a lower vertical member.

3. The fall prevention system of claim 2, wherein the second vertical member telescoping upward from within the lower vertical member is facilitated by a winch assembly comprising:
a winch assembly comprising that extends and retracts a second vertical member from within a lower vertical member, the winch assembly,
a frame configured on the lower vertical member and comprising:
an outer U-channel,
an inner U-channel,
a spool configured within the outer U-channel,
a hand crank attached to the spool and extending from the outer U-channel,
a cable comprising:
a first end secured to the spool, and
a second end extending upward from the spool, through an upper cable looping member, downward, and then secured to a lower cable attachment.

4. The fall prevention system of claim 3, wherein the winch assembly is permanently configured on the lower vertical member.

5. The fall prevention system of claim 3, wherein the winch assembly is removably configured on the lower vertical member.

6. A fall prevention system comprising:
a lower anchor comprising:
a bottom plate comprising:
bolt bore,
support gussets,
an opening,
an initial vertical member with a lower end and an upper end, the lower end dimensioned to fit within the opening on the lower anchor,
a connecting member having a lower opening and an upper opening, the lower opening dimensioned to accept the upper end of the initial vertical member,
an additional vertical member with a lower end and an upper end, the lower end dimensioned to fit within the upper opening on the connecting member,
an upper member with:
a lower end having an opening,
an upper end,
a horizontal section attached by attachment means to the upper end,
support gussets,
a plurality of cable securing means that are attached to at least one of the initial and additional vertical members,
connecting member and upper member,
at least one securing cable having a first end secured to one of the plurality of cable securing means, and a second end secured to a structural location,
a cable ratchet configured on the securing cable,
a harness configured to be worn by a person and comprising:
a harness cable that is secured to one of the plurality of cable securing means, and
a retracting/extending device.

7. The fall prevention system of claim 6, wherein the lower anchor, initial and additional vertical members, connecting member and upper member are comprised of metal tubing.

8. The fall prevention system of claim 6, wherein the additional second vertical member telescopes upward from within a lower vertical member.

9. The fall prevention system of claim 7, wherein the additional second vertical member telescoping upward from within the lower vertical member is facilitated by a winch assembly comprising:
an enclosure configured on the lower vertical member and having:
a motor that is configured with and powers a spool,
a cable with a first end secured to the spool that is configured with a raising and lowering mechanism, and a second end secured to the second vertical member, and
raising and lowering controls.

10. The fall prevention system of claim 6, wherein the winch assembly is permanently configured on the lower vertical member.

11. The fall prevention system of claim 6, wherein the winch assembly is removably configured on the lower vertical member.

12. The fall prevention system of claim 6, wherein the lower anchor, initial vertical member and additional vertical member are integrally manufactured as a single unit.

13. The fall prevention system of claim 6, wherein a bolt is inserted through each bolt bore on the lower anchor and into a ground level surface of a structure, thereby securing the lower anchor to the ground level surface.

14. The fall prevention system of claim 6, wherein each of the plurality of the cable securing means comprises a D-ring or a cotter pin assembly.

15. The fall prevention system of claim 6, wherein the at least one cable ratchet is configured to tighten the at least one securing cable attached to the fall prevention system and a structure location.

16. The fall prevention system of claim 6, wherein the harness comprises a body belt or a waist belt.

17. The fall prevention system of claim 6, wherein the retracting/extending device is configured to allow the harness cable to be maintained at an optimal length and to lock when a sudden tension is detected.

18. The fall prevention system of claim 6, further comprising an anchor base that is integrally attached to the anchor, and having at least two handles extending from an upper surface.

19. The fall prevention system of claim 6, further comprising a fall indicator configured with at least one constant or flashing light that is attached to the fall prevention system.

20. The fall prevention system of claim 19, wherein the fall indicator comprises an alarm that is audible through a speaker that is located on the vertical member, connecting member or inside or outside a structure being built.

21. The fall prevention system of claim 6, further comprising a body winch that is configured with the harness cable and has controls that are worn or accessible to a person wearing the harness.

22. The fall prevention system of claim 6, wherein the lower anchor and initial vertical member are integrally connected, forming a single unit.

23. The fall prevention system of claim 6, further comprising a securing rod with a clamp at each end, wherein the securing rod is clamped to the FPS and a section of a building frame.
